(19) United States
(12) Patent Application Publication
(10) Pub. No.: US 2006/0045471 A1
(43) Pub. Date: Mar. 2, 2006

(54) Recording device for community based recording

(75) Inventors: Adolf Proidl, Vienna (AT); Gerald Janisch, Wilhelmsburg (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/534,810

(22) PCT Filed: Oct. 31, 2003
(86) PCT No.: PCT/IB03/04921

§ 371 Date: May 12, 2005

(30) Foreign Application Priority Data
Nov. 18, 2002 (EP) 02102601.8

(51) Int. Cl. H04N 5/783

(52) U.S. Cl. 386/69; 386/70

(57) ABSTRACT

In a recording device (10, 20, 30) having program receiving means (2) for receiving audio/video programs, having program selecting means (12, 22, 23) for selecting receivable audio/video programs for recording on a recording medium (14, 24) or reproduction, and having storage means for storing a user identifier (ID) (13, 23, 33) identifying the recording device or a user thereof, the program selecting means (12, 22, 32) are now arranged to give access to a user profile (15, 55a, 55b) for the recording/reproducing device and to a group list (16, 56a, 56b) containing user identifiers for other recording/reproducing devices, and information receiving means (3) are provided for receiving sets of program selection information (11, 21, 31, 51) that can be correlated with the user identifiers (13, 23, 33) contained in the group list (16, 56a, 56b), wherein the program selecting means (12, 22, 32) are arranged to determine the audio/video programs to be selected, from the sets of program selection information (11, 21, 31, 51) received and by reference to the access to the user profile (15, 55a, 55b).

The invention relates to a recording device for recording audio/video programs on a recording medium and/or for reproducing them, having program receiving means for receiving audio/video programs, having program selecting means for selecting receivable audio/video programs for recording or reproduction, and having storage means for storing a user identifier (ID) identifying the recording device or a user thereof.

The invention further relates to a recording/reproducing system having at least two of the recording/reproducing devices specified in the first paragraph.

The invention further relates to a method of operating a server to obtain information from and transmit information to a plurality of recording/reproducing devices that are connected to the server and, if required, to one another by communication means.

A recording/reproducing device of this kind is known from GB patent 2,346,251 A. This document discloses a multi-user video recording/reproducing system where every user is identified by a user profile assigned to him that may contain restrictions relating to viewing times and program content. For each user, a program plan is kept containing a list of programs to be recorded. The television programs are recorded and are stored on a data carrier, e.g. a hard disk, to be viewed later. Each user can log on to the system and view television programs that have been recorded for him. A master user, such as a parent for example, can add new users to the system and define appropriate user profiles.

However, it has proved to be a disadvantage with the known recording/reproducing device that all the users are dependent on one master user who makes the crucial decisions relating to programs and viewing times. This may even be desirable for educational reasons in the case of a family where there are small children to keep them from seeing undesirable television programs. In the case of older children or users of full legal age however, a restriction of this kind—which they regard as patronizing—results in objections to the recording/reproducing device. On the other hand, given the vast number of programs that can be received nowadays, suitable programs can only be selected by spending a considerable amount of time and studying magazines giving program listings. Added to this is the fact that, particularly in the case of younger viewers and listeners, there is a noticeable need to be “in”, to belong to a “group”, which in turn means that there is the related desire to see or listen to those programs that the other members of the group are seeing or listening to, in order to be able to take part in discussions about these programs. The known recording/reproducing device offers no support in this regard and in fact the schedule of programs is preset by a person in authority (the master user).

It is an object of the invention to provide a recording/reproducing device of the kind specified in the first paragraph, a recording/reproducing system of the kind specified in the second paragraph, and a method of the kind specified in the third paragraph of operating a server to obtain information from and transmit information to a plurality of recording/reproducing devices, in which the disadvantages described above are avoided. To achieve this object, the program selecting means in a recording/reproducing device of the above kind are arranged to give access to a user profile for the recording/reproducing device and to a group list containing user identifiers (IDs) for other recording/reproducing devices, and information receiving means are provided for receiving sets of program selection information that can be assigned to the user identifiers contained in the group list, wherein the program selecting means are arranged to determine the audio/video programs to be selected, from the sets of program selection information received and by reference to the access to the user profile.

To achieve the object stated above, there are provided in a recording/reproducing system of the above kind communication means for transmitting sets of program selection information and user identifiers (IDs) between the recording/reproducing devices.

To achieve the object stated above, provision is made in a method of server operation of the above kind for the server to read in and store user identifiers (IDs) and associated sets of program selection information from the recording/reproducing devices connected to it, for it to manage and store group lists and/or user profiles, and, on being requested by a recording/reproducing device to transmit user identifiers (IDs), sets of program selection information, group lists and/or user profiles, for it to transmit the information requested to the recording/reproducing device.

What is achieved by the features according to the invention is that the user is provided with effective help in making decisions when selecting programs, in which case it is even possible for the program selection to be made automatically. At the same time, he is not dependent on the decisions made by the master user but, by setting his user profile in the appropriate way, can preset the framework conditions himself. As well as this, the invention also makes it possible for a plurality of recording/reproducing devices to be networked with one another and for the exchange of data to take place between all the recording/reproducing devices that are networked. This enables the recording/reproducing and viewing needs of the users, who want to know what their friends are recording/reproducing or watching, to be met in a far more satisfactory way than the known system does, which is restricted to a single unit and hence a single location.

By the provisions of claim 2, the advantage is obtained that recording/reproducing is not confined to the present moment in time and that recording/reproducing events can be pre-planned for the future. If the timer list is stored in a non-volatile memory in the recording/reproducing device, the device can operate in the stand-alone mode once the timer list has been created. Independence of a permanent communications link to other recording/reproducing devices is further increased if the group list and/or the user profile too can be stored in a non-volatile memory in the recording/reproducing device. As an alternative to the group list and user profile being stored in the recording/reproducing device, provision may also be made for them to be downloaded to the recording/reproducing device from a remote source via the information receiving means. The source should preferably be a server computer that can be reached at all times and that is responsible, if required, for managing a large number of group lists and user profiles.

By the provisions of claim 5, the advantage is obtained that the recording/reproducing device can actively communicate with other recording/reproducing devices and can thus influence the program selection at the other recording/reproducing devices. The user of the recording/reproducing device according to the invention can thus perform the role of a decision maker among his circle of friends and can thus become the “master of ceremonies”. For security and data-protection reasons, in a preferred embodiment transmission can be restricted by defined access rights.

By the provisions of claim 6, the advantage is obtained that the user of a TV set that is connected to, for example, an antenna for receiving satellite transmissions or to a cable TV network, and that thus enables dozens of programs to be received, does not have to search laboriously through magazines giving program listings to make a decision about programs. By virtue of the invention, he can now cause an automatic selection to be made by reference to the decision-making criteria set in his user profile or, preferably by means of an on-screen display, he can cause a shortlist comprising a few programs to be displayed directly on the screen and can made his final selection from this by means of his TV remote control.

By the provisions of claim 7, the advantage is obtained that a plurality of recording/reproducing devices are able to communicate with one another, which means that the question of the location of the devices becomes irrelevant and even the sets of program selecting information from far distant devices can be allowed for. In one embodiment, the communication means may comprise a peer-to-peer network employing a suitable data transmission protocol, thus enabling user identifiers and sets of program selection information to be exchanged between the devices in response to specific or broadcast requests. As an alternative to a peer-to-peer network, the communication means may take the form of a client/server network. For the individual recording/reproducing devices, this has the advantage that they only have to make contact with a server computer—whose availability is generally high—whereas in the case of a peer-to-peer network it has to be expected that many of the devices connected to the network will not be switched on at times.

By the provisions of claim 10, the advantage is obtained that the management of sets of program selection information, group lists and/or user profiles is dealt with centrally. Because the data is managed centrally in this way, on the one hand greater convenience and security is afforded when user profiles and group lists are being created, which can preferably be done from computer terminals, and on the other that the sets of data can be correlated with one another and added to. These facilities afforded by the central management in turn provide the foundation for a business model in which, for example, the creation of user profiles and group lists or access to such data is only enabled in return for remuneration, or advertising or free additional information is added to the data transmitted, or in which statistical information on listener/viewer habits, which can be sold to companies such as advertising agencies, is obtained from the data held in store. Finally, all the services mentioned can be organized and marketed as subscription systems.

These and other aspects of the invention are apparent from and will be elucidated with reference to the embodiments described hereinafter, to which however the invention is not limited.

In the drawing:

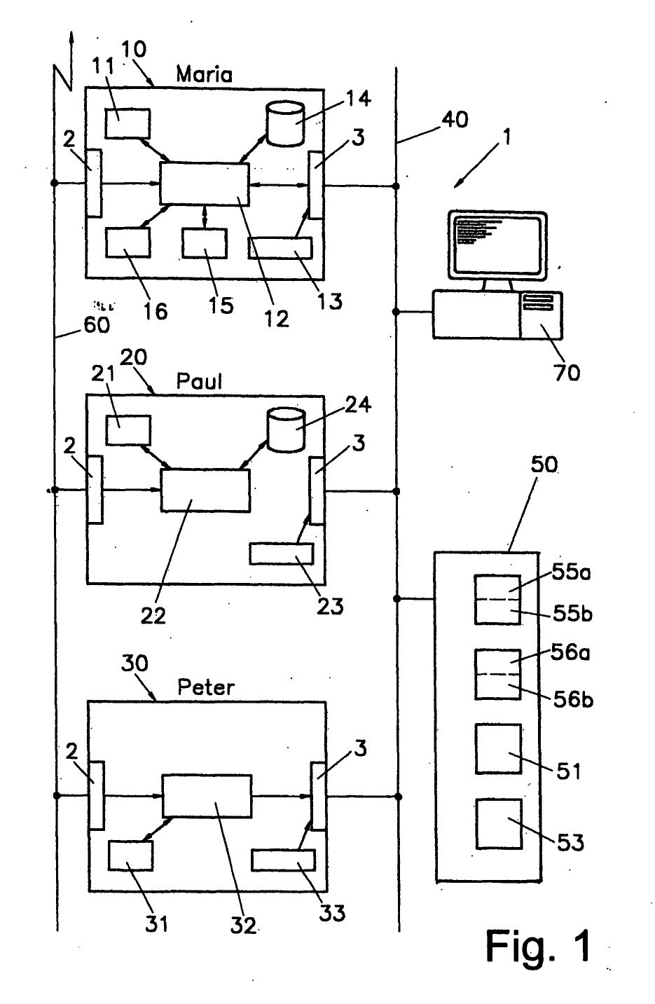

FIG. 1 shows a recording/reproducing system having a plurality of recording/reproducing devices that are connected to each other and to a server.

FIG. 1 is a block diagram of a recording/reproducing system 1 having the features of the present invention. The recording/reproducing system 1 comprises a plurality of recording/reproducing devices, of which three are shown in the drawing, these three being identified in general by the reference numerals 10, 20 and 30. Recording/reproducing device 10 is a video recorder that has a magnetic tape 14 as its recording/reproducing medium. Recording/reproducing device 20 is a DVD+RW device that has a DVD as its recording/reproducing medium 24. Recording/reproducing device 30 is in the form of a TV set. It may be mentioned that a personal computer having an integral TV interface card or other devices in the consumer electronics field would also be suitable as recording/reproducing devices. It may further be mentioned that the recording/reproducing media of the recording/reproducing devices could equally well be formed by a hard disk, or a semiconductor memory such as a flash memory. Associated with the three recording/reproducing devices 10, 20, 30 shown are respective users, whose names in the present example are Maria, Paul and Peter. Provision may be made for the users to have to log on by normal procedures, such for example as by entering a password, using a code card etc., to obtain an authorization to use the recording/reproducing device. Since in the domestic sphere a certain degree of security is ensured at the outset by the limited number of people who have access to the recording/reproducing device, provision may also be made for the entry of a password to be necessary only once when the recording/reproducing device is being set up and for the device to store this password to enable it to transmit the password automatically at the time of subsequent accesses to other recording/reproducing devices. Where there are a plurality of users of a recording/reproducing device, even a keypad key marked in color will for example be enough to select a given user profile. Each user is assigned a user identifier (ID) that is stored in the given device. In the present case Maria, the user of recording/reproducing device 10, is assigned the user identifier 13, Paul, the user of recording/reproducing device 20, is assigned the user identifier 23 and Peter, the user of recording/reproducing device 30, is assigned the user identifier 33. Where the recording/reproducing device is in the form of a single-user device, the user identifiers 13, 23 and 33 may be the same as the device identifiers, which latter may be preset in an unalterable form in the given device (in a similar way to the hardware addresses of computer network cards). It is however preferable, even where the recording/reproducing device is a single-user device, for the user identifier and device identifier to be kept strictly separate so that, if a recording/reproducing device of this kind is sold on or replaced, the user can continue to use his existing user profile with the new recording/reproducing device. Each of the recording/reproducing devices 10, 20 and 30 has program receiving means 2, e.g. a signal receiving circuit for connection to a cable TV network 60.

The program receiving means 2 may however also comprise a satellite TV receiver, and an input circuit for receiving signals from terrestrial TV antennas or digital signals. In the example shown, the programs received are TV programs, although the invention can equally well be applied to radio programs. A plurality of channels can be received over the cable TV network 60 and the selection of a program can be performed by means of program selecting means 12, 22 or 32. In accordance with the invention, the program selection is performed—as will be explained in more detail below—by the program selecting means 12, 22, 32 accessing user profiles 15, 55a or 55b associated with them and group lists 16, 56a or 56b having, contained therein, user identifiers of other recording/reproducing devices. Each recording/reproducing device 10, 20 and 30 further comprises information receiving means 3 for receiving sets of program selection information 11, 21, 31 or 51 from other recording/reproducing devices, in which case it must be possible for the sets of program selection information to be correlated with the user identifiers contained in the group lists 16, 56a and 56b. The information receiving means 3 are connected to one another, to a server 50 and to a computer terminal 70 by communications means 40. The communication means 40 are formed by a telecommunications network and a data transmission network. The internet would be particularly suitable as a communication means, in which case transmission protocols, such as, for example, TCP/IP, HTTP, XML/Jabber Instant Messaging etc., may be used. It is also possible for the communication means 40 to be so arranged that they also enable audio/video programs to be transmitted, by means of IP multicasting for example. In this event, the program receiving means 2 could be dispensed with.

From the sets of program selection information received and by reference to the user profile, the program selecting means 12, 22 and 23 determine the programs to be selected, in which case the procedures adopted differ slightly among the recording/reproducing devices shown. Recording/reproducing device 10 has non-volatile memories, in which are stored not only Maria's user identifier 13 and her user profile 15 but also the group list 16 that contains the user identifiers of other recording/reproducing devices that are to have a bearing on the program selection, meaning for example, in the present case, the user identifiers for recording/reproducing devices 20 and 30, i.e. those of Paul and Peter. Maria, Paul and Peter thus belong to the same virtual group. The program selecting means 12 cause the sets of program selection information 21 and 32 to be requested from the recording/reproducing devices 20, 30. The information received is analyzed in accordance with Maria's user profile 15 and results in the selection of programs that are stored in her own set of program selection information 11, which is organized as a timer list and contains details of the channel, the date and time when recording/reproducing is to begin and the time for which recording/reproducing is to last. Recording/reproducing device 10 is thus best suited to a peer-to-peer network in which the recording/reproducing devices connected to the network exchange the requisite information with one another without any central management being required.

This however is not the case with recording/reproducing devices 20 and 30. Although they too are fitted with non-volatile memories to store the user identifiers 23 and 33 and the sets of program selection information 21 and 31, they obtain the user profiles 55a and 55b, the group lists 56a and 56b, and the set of program selection information 51 directly from the server 50 with which they are connected via the communication means 40. Hence the recording/reproducing devices 20 and 30 do not themselves access other recording/reproducing devices but only the server 50. The server 50 in turn fetches the above information from the individual recording/reproducing devices and, where appropriate, performs additional processing on it by adding supplementary information, such as, for example, program metadata (program descriptions), to the set of program selection information 51 to make it easier for the user to find programs. The set of program selection information 51 may contain copies of the sets of program selection information 11, 21, 31 read in from recording/reproducing devices 10, 20 and 30, but it is also possible for the server 50 to pre-process the sets of program selection information 10, 20 and 30 that are read in. What is advantageous about the client/server conduct of the recording/reproducing devices 20 and 30 is that they do not have to constantly check to see whether the desired recording/reproducing devices whose user identifiers are contained in the group list can be reached via the communication means 40 and instead they can simply obtain the requisite information from the server, which is virtually always available.

In what follows, examples are given of how the user identifiers (IDs) 13, 23, 33, the group lists 16, 56a, 56b and the user profiles 15, 55a and 55b may be structured, in which case there are many modifications that are possible as a function of the implementation. Assuming that what is used as a communications protocol is the present applicant's “Jabber” messaging protocol, it is useful for the user name, the user address and a password to be held in the user identifier, i.e., “Maria; maria@jabber.philips.com; qwerrt2345” in user identifier 13, for example, “Paul; paul@jabber.philips.com; quio789” in user identifier 23, for example, and “Peter; peter@jabber.philips.com; yxcv92” in user identifier 33, for example.

The group lists 16, 56a, 56b may in turn contain the user names of the other or all the members of the group, i.e. Maria, Paul and Peter. Also, access rights should be defined, which may turn out to be very different among the members of the group, e.g. Maria (or rather the recording/reproducing device 10 associated with her) may read the sets of program selection information 21 and 31 of users Paul and Peter, but Peter may only read the program selection information 21 of Paul, and so on.

Defined in the user profiles 15, 55a, 55b are rules stating the criteria and priorities under which the program selection is to take place. The following rules for example may be defined in Maria's user profile:
a) Programs selected by self have top priority for recording/reproducing;
b) Programs that have been selected by both Paul and Peter are to be recorded.

Peter's user profile could be:
a) Paul's program selection is to be adopted if programs have been preprogrammed for the current point in time.

Since the recording/reproducing device 30 of the user Peter is a TV set, it makes no sense for a list of future programs to be kept. Rather than a given program being selected, all the programs selected at the time by the other members of the group could be displayed in an on-screen menu and the final choice could be left to Peter, which he would make by selecting an entry on the menu with his remote control.

To allow the user identifiers, user profiles and group lists to be defined, suitable input means may be provided on the recording/reproducing devices 10, 20 and 30. However, the above information can be defined in a particularly convenient way via the computer terminal 70, which is connected via the communications means 40 to the server 50 and the recording/reproducing devices 10, 30 and 30. A menu-prompted procedure for creating user identifiers, user profiles and group lists is an obvious candidate for this purpose, in which the assignment of the user identifier will be linked with registration, chargeable where required, on the server 50, in which case the communications protocol to be used may be selected as well. Following successful registration, the user may compile a group list from lists of options and may assign rights that state which members of the group are to have access to the above-mentioned information on his recording/reproducing device. The setting of a person's own user profile too can be performed via the computer terminal 70, in which case the selection may be made by following predefined or self-defined rules. The server 50 may be operated as a chargeable service.

1. A recording device (10, 20, 30) for recording audio/video programs on a recording medium (14, 24) and/or reproducing them, having program receiving means (2) for receiving audio/video programs, having program selecting means (12, 22, 23) for selecting receivable audio/video programs for recording or reproduction, having storage means for storing a user identifier (ID) (13, 23, 33) identifying the recording/reproducing device or a user thereof, characterized in that the program selecting means (12, 22, 32) are arranged to give access to a user profile (15, 55a, 55b) for the recording/reproducing device and to a group list (16, 56a, 56b) containing user identifiers (IDs) for other recording/reproducing devices, and in that information receiving means (3) are provided for receiving sets of program selection information (11, 21, 31, 51) that can be correlated with the user identifiers (13, 23, 33) contained in the group list (16, 56a, 56b), wherein the program selecting means (12, 22, 32) are arranged to determine the audio/video programs to be selected, from the sets of program selection information (11, 21, 31, 51) received and by reference to the access to the user profile (15, 55a, 55b).

2. A recording/reproducing device as claimed in claim 1, characterized in that the program selecting means (12, 22) are arranged to create a timer list for the time-controlled recording/reproducing of the receivable audio/video programs, the timer list preferably being storable in a non-volatile memory in the recording/reproducing device.

3. A recording/reproducing device as claimed in claim 1, characterized in that the group list (16) and/or the user profile (15) can be stored in a non-volatile memory in the recording/reproducing device (10).

4. A recording/reproducing device as claimed in claim 1, characterized in that the group list (56a, 56b) and/or the user profile (55a, 55b) are/is downloadable to the recording/reproducing device (20, 30) via the information receiving means (3).

5. A recording/reproducing device as claimed in claim 1, characterized by information transmitting means for transmitting the user identifier (ID) (13, 23, 33) and the program selection information (11, 21, 31) created by the program selecting means (12, 22, 32) on being requested to do so by external devices, the transmission preferably being limitable by reference to the access rights defined in the group list (16, 56a, 56b).

6. A recording/reproducing device as claimed in claim 1, characterized in that the recording/reproducing device (30) is a TV set and the programs selected by the program selecting means (32) are offered to a viewer via on-screen information, in which case a final selection can, where applicable, be made by the viewer, preferably via a remote control.

7. A recording/reproducing system (1) having at least two recording/reproducing devices (10, 20, 30) as claimed in claim 1, characterized in that communication means (40) for transmitting program selection information (11, 21, 31) and user identifiers (IDs) (13, 23, 33) are provided between the recording/reproducing devices (10, 20, 30).

8. A recording/reproducing system as claimed in claim 7, characterized in that the communication means (40) provide a connection to a server computer (50) that manages group lists (56a, 56b) and/or user profiles (55a, 55b) and/or user identifiers (IDs) (53) and associated sets of program selection information (51) from recording/reproducing devices connectable via the communication means.

9. A method of operating a server to obtain information from and transmit information to a plurality of recording/reproducing devices as claimed in claim 1 that are connected to the server and, if required, to one another via the communication means, characterized in that the server (50) reads in and stores (53, 51) user identifiers (IDs) (13, 23, 33) and associated sets of program selection information (11, 21, 31) from the recording/reproducing devices connected to it, and in that, on being requested by a recording/reproducing device (10, 20, 30) to transmit user identifiers (IDs), sets of program selection information, group lists (56a, 56b) and/or user profiles (55a, 55b), it transmits the information requested thereto while allowing for access rights.

10. A method of operating a server as claimed in claim 9, characterized in that the server adds additional information, e.g. program descriptions or advertising, to the stored sets of program selection information (51).

11. A method of operating a server as claimed in claim 9, characterized in that the server performs services for managing group lists and/or user profiles via remote computer terminals (70) with which it is connected via a data transmission network.

12. A method of operating a server as claimed in claim, characterized in that it controls access by recording/reproducing devices (10, 20, 30) or computer terminals (70) to the information managed by it by reference to subscriber lists.
